(19) United States
(12) Patent Application Publication
(10) Pub. No.: US 2003/0110117 A1
(43) Pub. Date: Jun. 12, 2003

(54) System and method for providing integrated applications availability in a networked computer system

(76) Inventors: Steven D. Saidenberg, New York, NY (US); William Joseph Fitzpatrick, Howell, NJ (US); Dominick Messano, Rockaway, NJ (US); Kathleen Y. Fahey, Stamford, CT (US)

Correspondence Address: Leslie Gladstone Restaino, Esq., Brown Raysman Millstein Felder & Steiner LLP, 163 Madison Avenue, P.O. Box 1989, Morristown, NJ, 07962-1989, US

(21) Appl. No.: 10/350,669

(22) Filed: Jan. 23, 2003

Related U.S. Application Data
(63) Continuation-in-part of application No. 09/696,693, filed on Oct. 25, 2000.
(60) Provisional application No. 60/182,364, filed on Feb. 14, 2000.

(51) Int. Cl. G06F 17/60

(52) U.S. Cl. 705/36

(57) ABSTRACT

The present invention provides systems and methods for providing integrated applications availability in a networked computer system. The system includes a network including at least one client computer and at least one host server computer. A host server computer engaged in a session with a client computer causes display of a window on a display device of a client computer, the window including a number of display areas, each of the display areas displaying initial content provided through a different application. Upon, for example, selection of a portion of one or the displays, a second window is displayed that includes additional content. Session information is stored in a database separately from the client computer and the host server computer engaged in the session. Session information obtained from the database is used in causing at least one of the display of the second window and display of a window comprising further content.

### CROSS-REFERENCE TO RELATED APPLICATIONS

The present application is a Continuation-In-Part of U.S. application Ser. No. 09/696,693, filed Oct. 25, 2000, and entitled, “System for Providing Financial Services,” which claims the benefit of U.S. Provisional Application Serial No. 60/182,364, filed Feb. 14, 2000, and entitled, “System for Providing Financial Services,” both of which applications are hereby incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

The present invention relates to financial business systems; and more particularly, to systems and methods for providing integrated applications availability in a networked computer system in which financial services are provided.

2. Description of the Related Art

The use of, and the need for, computer applications, including applications relating to investment and financial services continue to grow. Such applications are typically accessed in networked computer setting, and particularly via the Internet. In addition, the variety and quantity of such applications and the content and utilities they provide continues to expand rapidly.

Increasingly, the best informed financial decision-making or financial advice formulation can require rapid, convenient access to the wide variety of utilities and information now available through various often disparate applications, including, for example, applications to provide or assist in providing financial and market information, financial and investment planning and monitoring, financial and investment transactions, etc. This poses a problem, however, since multiple applications are difficult and inconvenient to access rapidly. For example, to access a particular application or suite of related applications, a user may need to open several different Web pages, logon to multiple accounts using multiple passwords, etc. Additionally, it is typically difficult to attain rapid access to the applications of a user's choice in anything other than a haphazard, inconvenient manner, such as by having multiple Web pages open and multiple sessions running simultaneously.

The state of the art reflects the trend for increasing attempts to computerize and automate financial services. For example, U.S. Pat. No. 5,132,899 discusses computerized data gathering and processing methods that facilitate access to various data, including investment performance, Securities and Exchange Commission reports, and stock financial characteristics, to produce a list of stocks for purchase for investment and operating accounts. U.S. Pat. Nos. 5,710,889 and 5,890,140 discuss a device and system for electronically integrating a plurality of financial services from different geographical locations and in different time zones.

Additionally, a number of computerized financial advisory systems have been developed. U.S. Pat. No. 5,918,217 discusses an interface that allows a user to interactively explore how changes to one or more input decisions, such as risk tolerance, savings level, and retirement age, affect one or more output values such as probabilities of achieving particular financial goals. For example, the Web site www.armchairmillionare.com/fivesteps/intro.html provides an interactive savings tool that explores how to build a million dollar portfolio based on total dollar inputs.

There have been some attempts to integrate different automated financial systems. U.S. Pat. No. 5,245,535 discusses a system for demonstrating and displaying different financial concepts which includes a central processing unit for processing financial information from numerical data and a display means for displaying the financial data in graphic and textual form. U.S. Pat. No. 5,214,579 discusses a data processing system that manages, monitors, and reports growth of a participant's investment base with respect to progress in achieving a predetermined target amount.

The state of the art, as represented by the systems discussed above, does not include a system for providing secure, convenient and integrated access to a variety of financial applications, tools, and content in a networked computer setting, such as a networked computer setting including the Internet.

For all of the above reasons, there is a need in the art for systems and methods for providing integrated applications availability in a networked computer system in which financial services are provided.

### SUMMARY OF THE INVENTION

The present invention provides for systems and methods for providing integrated applications availability in a networked computer system in which financial services are provided.

In one embodiment, the invention provides, in a networked computer system in which financial services are provided, a system for providing integrated availability of a plurality of applications. The system includes a network, at least one host server computer connected to the network, and at least one client computer connected to the at least one host server. During a session between a first host server computer of the at least one host server computer and a first client computer of the at least one client computer, the first host server computer causes a Web page to be displayed on a display device of the first client computer, the Web page comprising a plurality of display areas, each of the display areas displaying initial content provided through a different set of one or more applications. A portion of each of the display areas is selectable to cause a second window to be displayed on the display device, the window comprising additional content related to the content of the display area containing the selectable portion. Session information relating to the session is stored in a database separately from the first host server computer and separately from the first client computer. Session information is obtained from the database and used in causing at least one of the display of the second window and display of a window comprising further content related to the additional content.

In another embodiment, the invention provides, in a networked computer system in which financial services are provided, a system for providing integrated availability of a plurality of applications, the system including at least one host server computer connected to the Internet and at least one client computer connected to the at least one host server computer. During a session between a first host server computer of the at least one host server computer and a first client computer of the at least one client computer, the first host server computer causes a Web page to be displayed on a display device of the first client computer, the Web page comprising a plurality of display areas, each of the display areas displaying initial content provided through a different set of one or more applications. At least a portion of each of the display areas is selectable to cause a window to be displayed on the display device, the window comprising additional content related to the content of the display area containing the selectable portion. Session information relating to the session is stored in a database separately from the first host server computer and separately from the first client computer. Session information is obtained from the database and used in causing at least one of the display of the window and display of a window comprising further content related to the additional content.

Another embodiment of the invention provides, in a networked computer system in which financial services are provided, the system including at least one server computer connected to the Internet and at least one client computer connected to the at least one server computer, a method for providing integrated availability of a plurality of applications. During a session between a first host server computer of the at least one host server computer and a first client computer of the at least one client computer, the first host server computer causes a Web page to be displayed on a display device of the first client computer, the Web page including a plurality of display areas, each of the display areas displaying initial content provided through a different set of one or more applications. The method further includes displaying a window on the display device, the window comprising additional content related to the content of a display area of the plurality of display areas. The method further includes storing session information relating to the session in a database separately from the first host server computer and separately from the first client computer, and using session information obtained from the database in causing at least one of the display of the window and display of a window comprising further content related to the additional content.

In another embodiment, the invention provides computer usable media storing program code which, when executed on one or more computerized devices, causes the computerized devices to execute, in a networked computer system in which financial services are provided, the system comprising at least one server computer connected to the Internet and at least one client computer connected to the at least one server computer, a method for providing integrated availability of a plurality of applications. The method includes, during a session between a first host server computer of the at least one host server computer and a first client computer of the at least one client computer, the first host server computer causing a Web page to be displayed on a display device of the first client computer, the Web page including a plurality of display areas, each of the display areas displaying initial content provided through a different set of one or more applications. The method further includes displaying a window on the display device, the window comprising additional content related to the content of a display area of the plurality of display areas. The method further includes storing session information relating to the session in a database separately from the first host server computer and separately from the first client computer, and using session information obtained from the database in causing at least one of the display of the window and display of a window comprising further content related to the additional content.

Additional aspects of the present invention will be apparent in view of the description which follows.

### BRIEF DESCRIPTION OF THE FIGURES.

The invention is illustrated in the figures of the accompanying drawings which are meant to be exemplary and not limiting, in which like references are intended to refer to like or corresponding parts, and in which:

FIG. 1 is a block diagram depicting a networked computer system, according to one embodiment of the invention;

FIG. 2 is a block diagram depicting one embodiment of a networked computer system in accordance with the system depicted in FIG. 1;

FIG. 3 is a flow diagram depicting a method for processing a Hypertext Transfer Protocol (HTTP) request, according to one embodiment of the invention;

FIG. 4 is a block diagram depicting wrapper functions for session, request, and response objects, according to one embodiment of the invention;

FIG. 5 is a block diagram 500 depicting launching of an applications integration program, according to one embodiment of the invention;

FIG. 6 is an example of a first tier navigation home page, according to one embodiment of the invention;

FIG. 7 is an example of a second tier navigation Web page, according to one embodiment of the invention;

FIG. 8 is an example of a third tier navigation display, according to one embodiment of the invention;

FIG. 9 is an example of a first display of a site map, according to one embodiment of the invention;

FIG. 10 is an example of a second display of the site map of FIG. 9, according to one embodiment of the invention;

FIG. 11 is an example of a “Rates” contentlet, according to one embodiment of the invention;

FIG. 12 is an example of a “Research” contentlet, according to one embodiment of the invention;

FIG. 13 is an example of a “Top Holdings” contentlet, according to one embodiment of the invention;

FIG. 14 is an example of a “Today's Ratings Changes” contentlet, according to one embodiment of the invention;

FIG. 15 is an example of a “Today's Idea's and Opportunities” contentlet, according to one embodiment of the invention;

FIG. 16 is an example of a “National Rates” contentlet, according to one embodiment of the invention;

FIG. 17 is an example of a “Stat List” contentlet, according to one embodiment of the invention;

FIG. 18 is an example of a “Monitor Summary” contentlet, according to one embodiment of the invention;

FIG. 19 is an example of a “Scrolling Headlines” contentlet, according to one embodiment of the invention; and

FIG. 20 is an example of a “My Day” contentlet format, according to one embodiment of the invention.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In addition to previously incorporated by reference and related U.S. application Ser. No. 09/606,693, filed Oct. 25, 2000, and entitled, “System for Providing Financial Services,” and U.S. Provisional Application Serial No. 60/182,364, filed Feb. 14, 2000, and entitled, “System for Providing Financial Services,” the systems described in following published international applications contain features which can be used in the practice of various embodiments of the present invention, and each is hereby incorporated herein by reference in its entirely: published international application no. WO 01/50317, published on Jul. 12, 2001 and entitled, “On-Line Trading System”; published international application no. WO 01/61590, published on Aug. 23, 2001 and entitled, “System for Providing Financial Services”; published international application no. WO 01/61589, published on Aug. 23, 2001 and entitled, “Browser Interface and Network Based Financial Services System”; and, published international application no. WO 01/61535, published on Aug. 23, 2001 and entitled, “System and Method for Execution of Trades Made Pursuant to Stock Option and Purchase Plans.” Additionally, U.S. patent application Ser. No. 10/026,747, filed on Dec. 20, 2001 and entitled, “System and Method for Facilitating Securities Borrowing Transactions” contains features that can be used in the practice of various embodiments of the present invention, and is hereby incorporated herein by reference in its entirety.

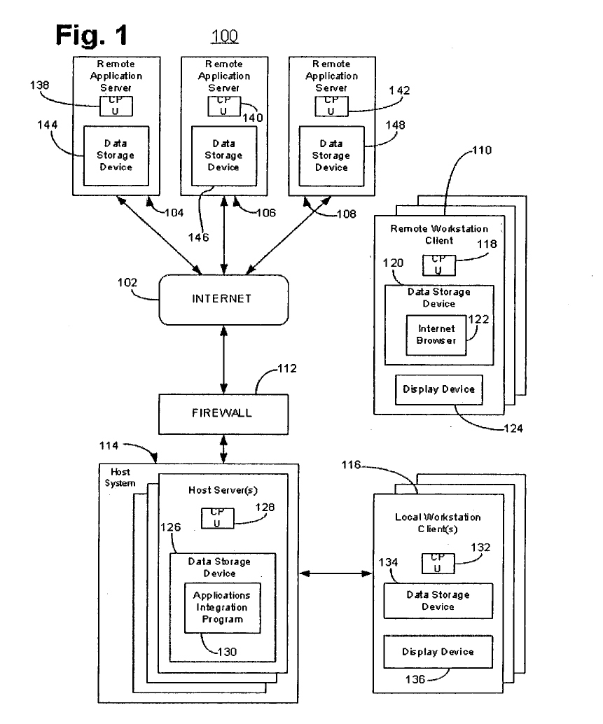

FIG. 1 is a block diagram depicting a networked computer system 100, according to one embodiment of the invention. As depicted, the Internet connects one or more remote application server computers 104, 106, 108 (three are shown), one or more remote workstation client computers 110, and one or more host server computers 114. One more local workstation client computers 116 are connected to the one or more host server computers 114, and may be connected to the Internet 102. One or more firewalls 112, as known in the art, such as a packed filter firewall, circuit gateway firewall, application gateway firewall, or trusted gateway firewall, which can comprise various hardware and software, provides secured access via the Internet to the one or more host server computers 114. Although the Internet 102 is depicted, the invention contemplates embodiments in which the computers 104, 106, 108, 110, 114, 116 are connected in other ways, such as by other networks which can include personal area networks (PANs), local area networks (LANs) or wide area networks (WANs), and the invention contemplates embodiments in which no Internet connection is provided. Although the embodiment depicted includes the remote workstation client computers 110, and the local workstation client computers 116, in other embodiments of the invention, either the remote workstation client computers 110 or the local workstation client computers 116 are not included. The host server computers 114 represent the computers themselves as well as any networks, connections, or communication channels between them.

Each of the computers 104, 106, 108, 110, 114, 116 comprises one or more Central Processing Units (CPUs) 138, 140, 142, 118, 132, 128, and one or more data storage devices 144, 146, 148, 120, 126, 134. The remote workstation computers 110 comprise display devices 124, such as monitors or any form other video, graphical, visual or other device producing a display.

The data storage devices 144, 146, 148, 120, 126, 134 can comprise various amounts of RAM for storing computer programs and other data. The data storage devices 120 of the remote workstation client computers 110 include an Internet browser program or application, such as Internet Explorer® by Microsoft®. In addition, the computers 104, 106, 108, 110, 114, 116 can include other components typically found in computers, including one or more output devices such as monitors, other fixed or removable data storage devices such as hard disks, floppy disk drives and CD-ROM drives, and one or more input devices, such as mouse pointing devices, non-mouse pointing devices, or other devices allowing selection from a display device, and keyboards.

Generally, both the server computer 102 and the client computers 118a-c operate under and execute computer programs under the control of an operating system, such as Windows, Macintosh, UNIX, etc. Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

The data storage devices 126 of the host server computers 114 comprise an applications integration program 130. The applications integration program 130 broadly represents all programming, including applications, application programming interface (API) tools or other tools residing in or otherwise affecting operation of the host server computers 114 to allow the server computers 114 to facilitate providing the systems and methods of the invention as described herein, which can include facilitating providing integrated applications availability systems and methods according to the invention.

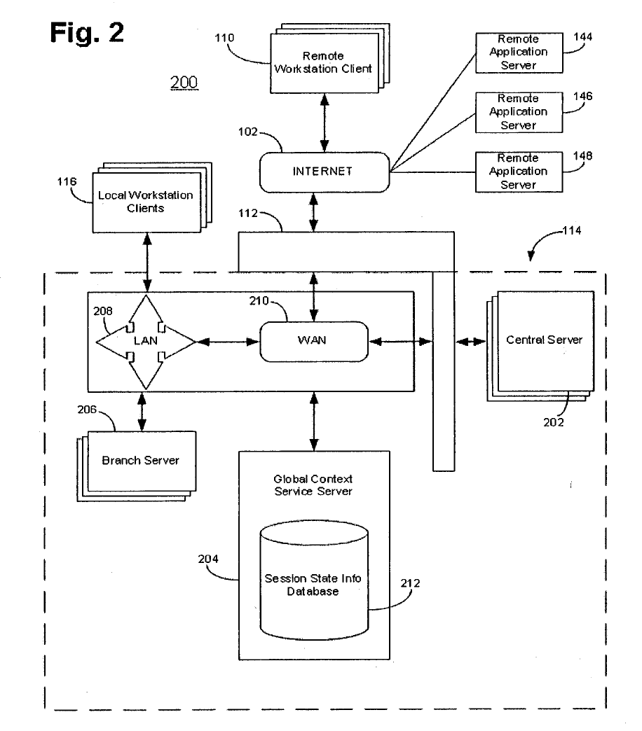

FIG. 2 is a block diagram depicting one embodiment of a networked computer system 200 in accordance with the system 100 depicted in FIG. 1. The host server computers 114 depicted in FIG. 1 are depicted in FIG. 2 as including branch server computers 206, central server computers 202, and global context services server computer 204, as well as LAN 208 and WAN 210.

Many of the elements depicted in FIG. 2 correspond generally to elements described in detail in previously incorporated by reference and related U.S. application Ser. No. 09/606,693, filed Oct. 25, 2000, and entitled, “System for Providing Financial Services.” Specifically, as depicted and described in U.S. application Ser. No. 09/606,693 particularly with reference to the embodiment depicted in FIG. 2 therein, branch server computers can include one or more network based server computers, one or more database server computers, and one or more market data server computers. Additionally, central server computers can include one or more security server computers, one or more market data server computers, one or more master entitlement database computers, one or more product server computers, and one or more mainframe computers. Other server computers can include one or more Internet investment product server computers. Various features as described in U.S. application Ser. No. 09/606,693 are generally applicable to the system 200 depicted in FIG. 2 herein, including, for example, functionality and implementation details described with respect to host server computers, entitlement and authentication, software, application interface, and workstation client computers.

In the embodiment depicted in FIG. 2 herein, included among the host server computers 114 is global context service computer 204, which includes session state information database 212. It is to be noted that, in some embodiments of the invention, the functions of global context server computer 204 can be provided by one or more other host server computers 114. Additionally, in some embodiments, the session state information database can be located separately from and accessible by the global context server computer 204.

In some embodiments of the invention, as will be shown and described in detail with reference to later figures, the host server computers 114 cause a window, such as a Web page, to be displayed on a client computer. A brief overview of some of the features of some embodiments of displays and navigation according to the present invention is here provided to support the following description of the global content services server computer 204 and the session state information database 212. The Web page can be a composite, including a number of display areas that display content or provide functionality provided through various applications, which can include various disparate financial or investment services related applications, and can include applications that provide real time or almost real content such as up to date market indicators, stock prices, tickers, and the like. A user of a client computer can select or otherwise interact with various display portions to cause additional windows to be displayed that additional content or functionality.

In some embodiments, interaction of the user of with multiple applications, via the display portions of the Web page and windows accessed via the Web page, is visibly indistinguishable to the user from interaction with a single application. In addition, in some embodiments, various aspects and functionality of the platform or operating environment are streamlined or made similar from display portion to display portion, or from window to window, despite the fact that the display portions or windows provide content or functionality through disparate applications with different platform or operating environment characteristics, or each having a different “look and feel.” In this way, the user's experience resembles or is indistinguishable from an experience of a single application, so that the user obtains the advantages of convenient and integrated access to and interaction with various applications.

To support the above, however, the server computers 114, including, in some embodiments, the global context services server computer 204, must be able to provide, in some embodiments, integrated displays including content obtained through several applications. For example, in a particular session between a client computer and the host server computers 114, a user of the client computer can obtain content from a first application or applications. Later in the session, or during a later session, the user may make a selection or input that requires that a second application or applications utilize data obtained previously through the first application or applications, possibly along with other data, such as data obtained through the second application or applications, or other applications. In some embodiments of the invention, the global context services server computer 204 is used in order to facilitate such actions in an integrated and secure manner. In some embodiments, the global context services server computer 204 serves as a secure, centralized source of session information obtained through various applications.

In some embodiments, the global context services server computer 204 is a separate computer from a host server computer with which a client computer is having a session, via the Internet, an intranet, or otherwise. In such embodiments, because the global context services server computer 204 is separate from the host computer engaged in the session, session state information, which might be lost if saved at the engaged host server computer or the client computer in the event of an abrupt session disengagement, can be communicated to and stored in the session state information database securely and more safely. Additionally, using the global context services server computer 204 has other advantages over storing session information in the client computer, such as by using cookies. For example, applications accessed by the client computer may not have ready access to the information stored at the client end. Furthermore, security can be severely compromised if an application is able to “reach into” the client computer through a public interface. As depicted in the embodiment of FIG. 2, the global context services server computer 204 is protected from public interface by the firewall 112, yet separate from both the engaged host server computer as well as the client computer, providing great security advantages.

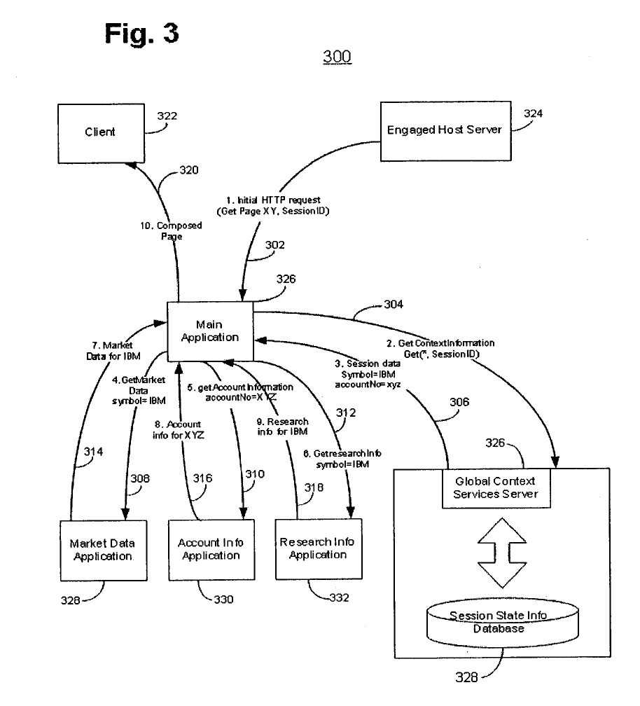

FIG. 3 is a flow diagram depicting a method 300 for processing a Hypertext Transfer Protocol (HTTP) request, according to one embodiment of the invention. In the embodiment depicted in FIG. 3, it is assumed that a client computer 322 is in session (engaged with) with a host server computer 324. The main application 326 as well as the market data application 328, account information application 330, and research information application 332 can be provided by different application server computers via Internet 102. The main application 326 can be, for example, an application accessible by a user of the client computer 322 via interaction with a portion of a display of a composite Web page provided using the engaged server computer 324. Furthermore, the other applications 328, 330, 332 can be applications accessed by the main application 326 to fulfill the an HTTP request issued by the engaged server computer, for example, in response to a user selection from or other interaction with a portion of a Web page provided using the engaged server computer 324.

At step 302, the engaged host server computer 324 initiates the initial HTTP request. At step 304, the main application 326, which, in various embodiments, can be executed from the engaged host server computer 324 or elsewhere, queries global context server computer 326 to obtain session information needed to fulfill the initial HTTP request, the session information being stored in session state database 328. In addition, in order for the main application 326 to fulfill the initial HTTP request, it has to then issue HTTP requests to the other applications as depicted in steps 304, 312, 308. In the embodiment depicted, session information, obtained by the main application 326 from the session state database 328 and needed by the other applications 328, 330, 332 to fulfill the HTTP requests sent to them by the main application 326, is added to HTTP requests issued in the steps 304, 312, 308. At steps 306, 318, 316, 314, each of the other applications 328, 330, 332 answers the HTTP requests 304, 312, 308. Although, at step 304, session information is initially obtained from the global context services server computer, at the steps 314, 316, 318 session information is propagated between applications 326, 328, 330, 332 rather than obtained from the global context services server computer 326. At step 320,the main application, or the engaged host server computer 324 through the main application, causes a composed Web page to be sent to the client computer 322. In some embodiments, all requests use an encrypted session token created at user login via the client computer 322 as a key to access session data from the session state database 328.

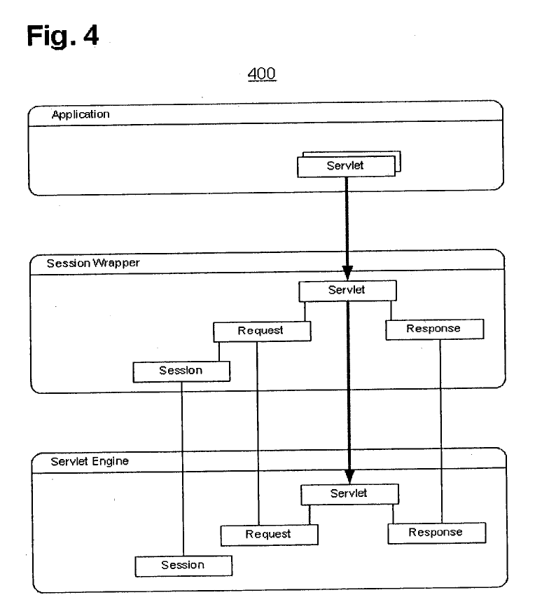

FIG. 4 is a block diagram 400 depicting wrapper functions for session, request, and response objects, according to one embodiment of the invention.

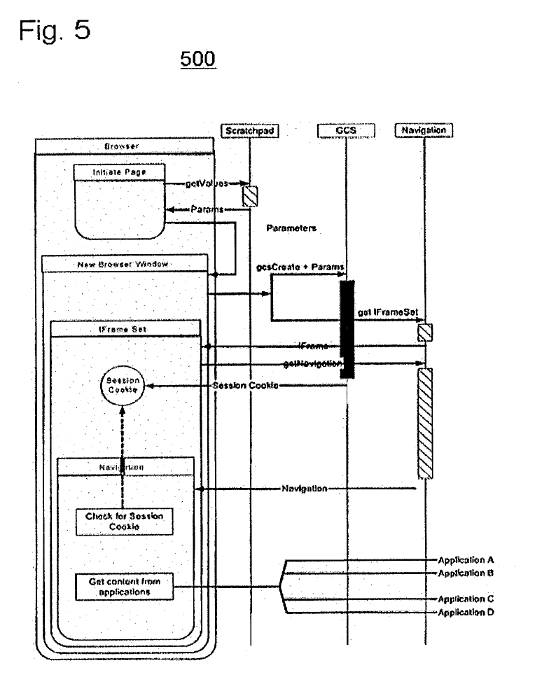

FIG. 5 is a block diagram 500 depicting launching of an applications integration program, according to one embodiment of the invention.

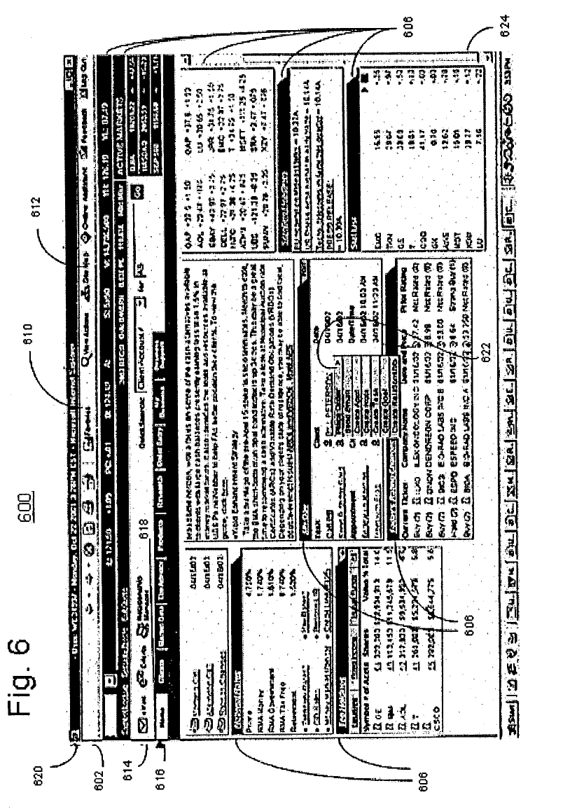

FIG. 6 is an example of a first tier navigation Web page, specifically, a home page 600, according to one embodiment of the invention. In the embodiment depicted, upon user login at a client computer, an applications integration program facilitates construction of and sending to the client computer a Web page, specifically, a home page. In constructing the home page 600, content is obtained from numerous applications, some of which can be stored in one or more host server computers, and some of which can reside on Internet-based application server computers.

The home page 600 includes, among other features, title bar 620, scroll bar 624, a masthead toolbar 602, first and second tier navigation tool bar 616, numerous areas having displays of content, or contentlets 606. As depicted, contentlets have associated pop-up menus 622. The masthead toolbar contains tools including “Favorites” 610 and “Sitemap” 612, including associated icons. An additional tool bar 614 contains icons for accessing applications such as an e-mail application.

In some embodiments, the Home page 600 contains contentlets including real-time or almost real-time data, and the Home page is dynamically constructed by the applications integration program upon, for example, secured login of a user at a client computer. In some embodiments, the applications integration program verifies a user's entitlements to each application used in providing contentlets, prior to constructing or completing construction of the home page, and not presenting displays to which a user is not entitled.

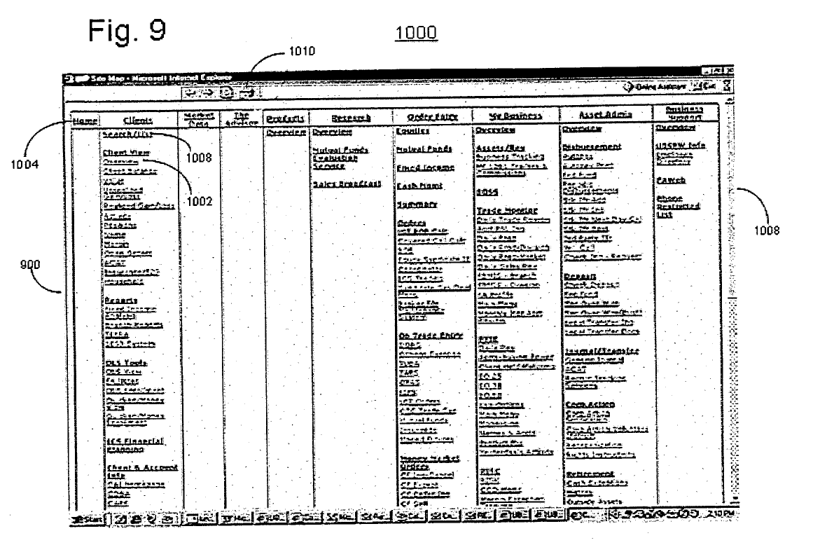

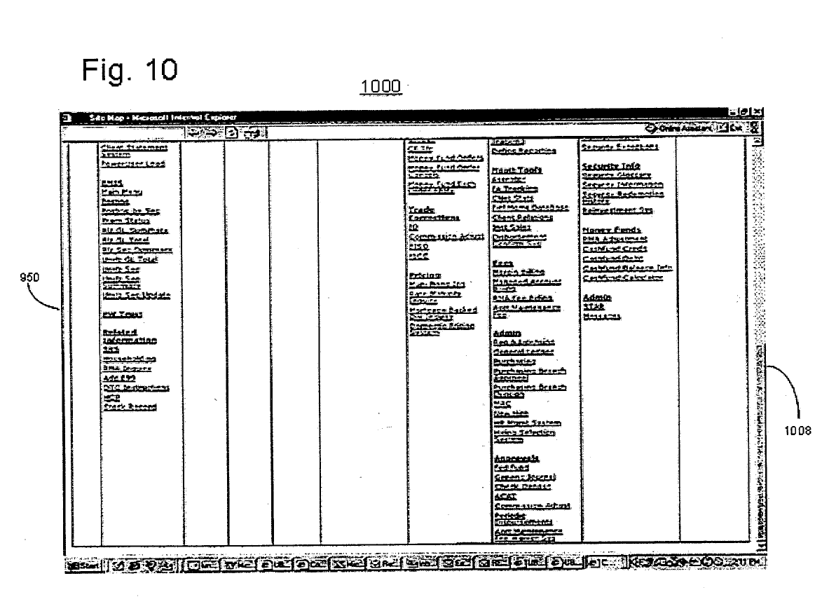

As depicted, the masthead toolbar 602 contains tools including “Favorites” 610 and “Sitemap” 612, including associated icons. Some tools can be used by the user to conveniently access applications associated with the displayed page, other Web pages associated with the Home page 600, such as second or later tier Web pages (as discussed further below), or other navigation utilities. For example, the “favorites” tool can present to the user a menu customized by the user, whether during a present session or an earlier session, allowing the user convenient access to frequently used applications, utilities, and the like. The “site map” tool can present a map of first and later tier Web sites (as described below with reference to FIGS. 9 and 10.)

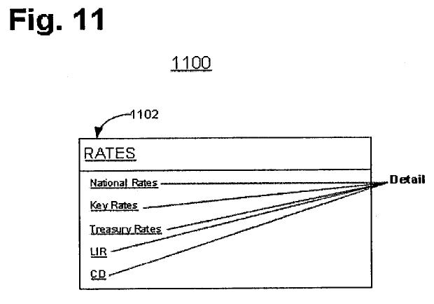

Each of the contentlets 606 can provide content or access to utilities of one or more applications, as well as provide links to associated Web pages. Some embodiments of contentlet examples and details are described in more detail with reference to FIGS. 11-20.

In some embodiments, pop-up menus 622 are associated with certain contentlets, and can appear, for example, if a user points to a region of the contentlet for a certain amount of time. In some embodiments, the applications integration program causes pop-up menus and other display and navigation formats to remain the same, similar, or streamlined for associated contentlets at different tier displays, or for different tier displays generally, which can help create an integrated user experience which can resemble or be visually indistinguishable, or transparent, to the user from an experience associated with the use of a single application, even though numerous applications and content from numerous applications can be presented and interacted with by the user.

The various contentlets can include, for example, various financial and investment related content, allow access to related applications or tools, provide real time or almost real time market data or news, etc. In some embodiments, some of the numerous contentlets displayed on the Web page provides a user with summaries or overviews of various data or topics, in an integrated, organized manner and format. Contentlets can also include links to related Web sites such as lower tier Web sites, or other tools, as described further below.

As depicted, the “Home” button 618, which can be the default button, is highlighted in the first and second tier navigation tool bar 616. The Home page 600 is herein referred to as a “first tier” Web page, while other Web pages selectable using the first and second tier navigation tool bar and, in some embodiments, generally contain more focused content than the Home page, are referred to as second tier Web pages. As depicted, the Web site includes numerous groups of Web pages at different hierarchical and navigational tiers. As depicted, the Home page 600 is the default Web page. Second tier Web page titles are also displayed in first and second tier navigation tool bar 616, such as “Clients,” “Market Data,” etc., which Web pages can be presented by selecting the appropriate button on the tool bar 616.

In various embodiments of the invention, users can include, for example, financial or investment advisors or other professionals, and contentlets can include contentlets with information on particular clients, the content of which contentlets may be searchable, organizable, or otherwise customizable by the user. In some embodiments, users can include non-professionals, such as clients of the professionals or subscribers.

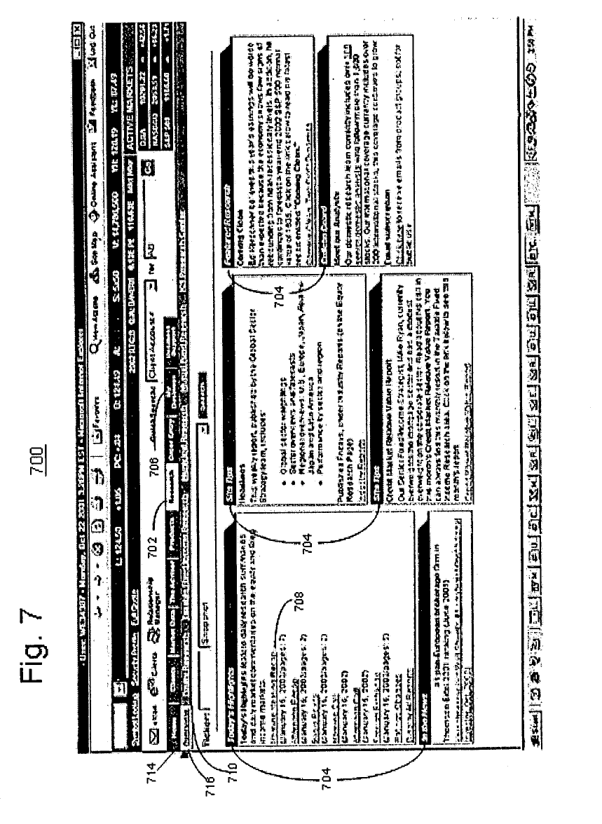

FIG. 7 is an example of a second tier navigation Web page 700, according to one embodiment of the invention. On first and second tier tool bar 714, the “Research” button 702 is highlighted. The Web page 700 is an example of a second tier Web page that can be displayed if a user, viewing Home page 600, selected the “Research” topic button. Each second tier Web page under the “Research” topic can include various contentlets 704 that generally relate to the topic “Research” and also relate to a more specific topic of the title of each Web page. In some embodiments, second and lower tier Web pages can be customizable by a user.

As depicted, selecting the “Research” button 702 causes a second tier secondary navigation tool bar 716 to appear, which allows selection between a number of second tier Web pages associated with the “Research” topic button, including, in this example, a default Web page titled “Overview” 710, which button is highlighted. The contentlets 704 generally relate to the topic of “research” and the topic of the title of the Web page 700, “Overview.”

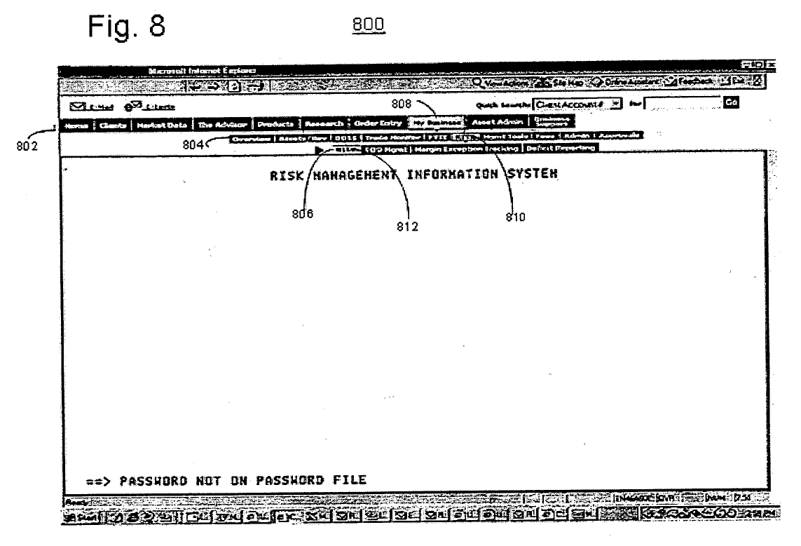

FIG. 8 is an example of a third tier navigation display 800, according to one embodiment of the invention. As depicted, first and second tier navigation tool bar 802 has a “My Business” button highlighted, second tier secondary navigation tool bar 804 has an “RISK” button 804 highlighted, and third tier navigation tool bar 806 has a “RISK” button 812 highlighted. Third tier navigation can lead to composite Web pages, such as Home page 600 and Web page 600, or other Web pages, windows, or other tools. As depicted, the third tier navigation display 800 is to provide access to a risk management application.

Generally, the tiered structure as depicted in FIGS. 6-8 allows user drill down capability to lower (numerically higher) tiers to obtain expanded, more detailed, or otherwise related information with respect to information obtained at higher (numerically lower) tiers.

FIGS. 9 and 10 show an example of a first display 900 and second display 950, respectively of a site map 1000, according to one embodiment of the invention. The site map 1000 can be displayed if a user selected the site map icon 612 (as depicted in FIG. 6) from the home page 600 or another Web page of the site. A scroll bar 1008 is provided to allow a user to scroll to view a site map that occupies more than one display screen. As depicted in FIG. 9, the site map 1000 is divided into columns 1004, the first row of each column listing a first tier Home page or second tier Web page. Each of the columns 1004 contains links such as hyperlinks to other Web pages or windows associated with the site, such as, in this example, the “Overview” second tier Web page title 1006, or to audio files, video files, streaming audio or video files, etc. The hyperlinks can be organized under the associated navigational topic, such as “Search/List” 1008. In some embodiments, the site map, as well as other Web pages and window displays associated with the site, can be printed, for example, by selecting the print icon 1010.

Generally, the site map provides a user with a convenient overview of the Web site, organized to reflect the hierarchical and topical organization of the Web site, and allowing rapid navigation to the Web page of the user's choice.

FIGS. 11-20 generally provide examples of contentlets according to some embodiments of the invention. In some embodiments of the invention, the global context services server computer 204 and the state information database 212 are used in providing Web pages or contentlets described herein, in the manner described above with reference to FIGS. 1-5.

FIG. 11 is an example of a “Rates” contentlet 1100, according to one embodiment of the invention. The rates contentlet 1100 includes a contentlet title 1102 as well as, in this case, hyperlinks 1104 to Web pages associated with the contentlet and the text of the hyperlink 1104. For example, in some embodiments, such hyperlinks can cause navigation to a publicly accessible Web page, such as www.Bloomberg.com, in which desired information can be obtained. In some embodiments, the publicly accessible Web page opens as a daughter window, leaving the Web page with the contentlet open.

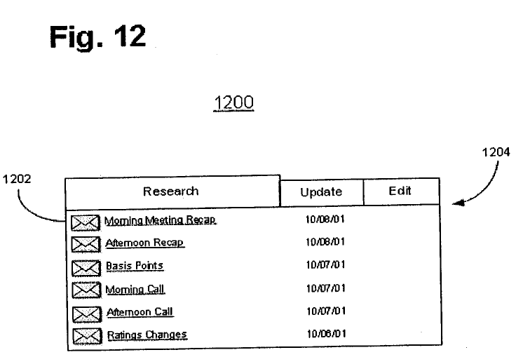

FIG. 12 is an example of a “Research” contentlet 1200, according to one embodiment of the invention. In some embodiments, the Research contentlet 1200 provides links 1202 to text, audio, or video files associated with the text of the link 1202. In addition, the contentlet includes a title bar having electronic tabs 1204 which can allow functions associated with the contentlet, its format, or the content it displays.

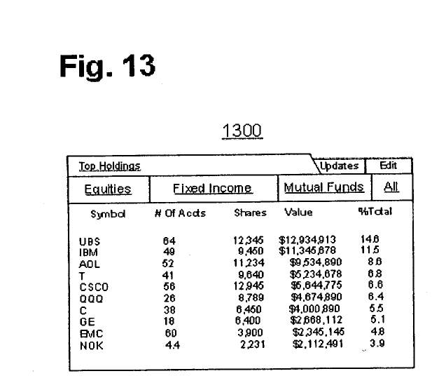

FIG. 13 is an example of a “Top Holdings” contentlet 1300, according to one embodiment of the invention. In some embodiments, the top holding contentlet 1300 can provide a summary of a user's or a user's client's holdings, and can include real time or almost real time tickers or other information with current market price or current holdings information.

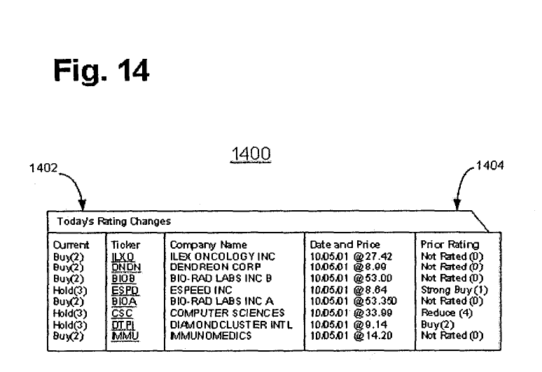

FIG. 14 is an example of a “Today's Ratings Changes” contentlet 1400, according to one embodiment of the invention. In some embodiments, the Today's Ratings Changes contentlet 1400 provides real time or almost real time information regarding certain holdings or financial instruments, including instruments with changed ratings, such as investment desirability ratings, which information can include previous ratings indications 1402 as well as current ratings indications 1404.

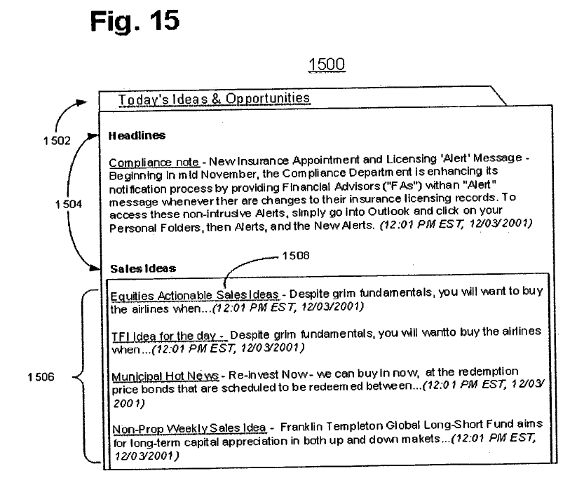

FIG. 15 is an example of a “Today's Idea's and Opportunities” contentlet 1500, according to one embodiment of the invention. In some embodiments, the Today's Idea's and Opportunities contentlet 1500 provides information such as current “hot” news or asset gathering ideas for financial or investment advisors or other professionals. The Today's Idea's and Opportunities contentlet 1500 can be organized according to headings 1504, and can provide links such as links 1508 to articles associated with the content of the contentlet 1500.

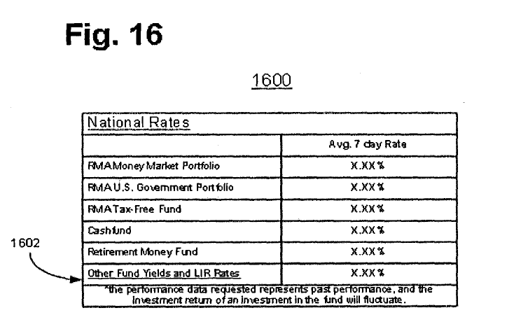

FIG. 16 is an example of a “National Rates” contentlet 1600, according to one embodiment of the invention, which can provide current interest rate information and links to sources for further related information.

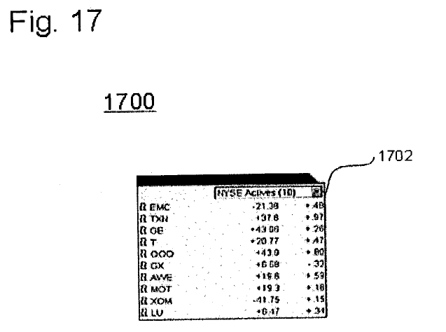

FIG. 17 is an example of a “Stat List” contentlet 1700, according to one embodiment of the invention. The Stat List contentlet 1700, in some embodiments, allows, using dropdown menu 1702, toggling between various financial indices and matrices to provide comprehensive information relating to several market indicators, such as, as depicted New York Stock Exchange information.

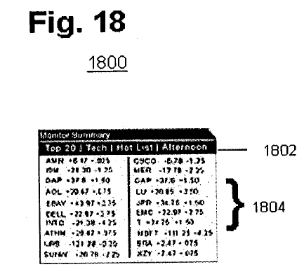

FIG. 18 is an example of a “Monitor Summary” contentlet 1800, according to one embodiment of the invention. In some embodiments, the Monitor Summary contentlet 1800 is customizable by a user, so that it is assembled to include market information about investment instruments, such as stocks, which the user has a particular interest, or is expected to have a particular interest, in monitoring. Selection bar 1802 allows selection of particular lists to be displayed, in area 1804, of such investment instruments, such as “Top 20,” “Tech” or technology, “Hot list” which can include stocks believed to be currently desirable to buy.

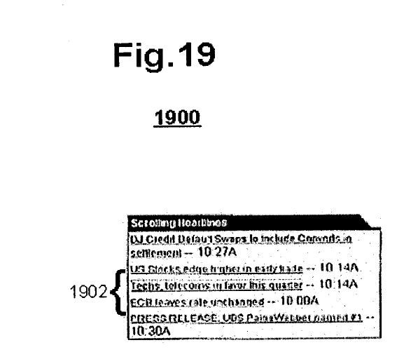

FIG. 19 is an example of a “Scrolling Headlines” contentlet 1900, according to one embodiment of the invention. The Scrolling Headlines contentlet 1900 can provide a displayed list 1902 of current news summaries and links to more information, which list can automatically scroll down over time, or can automatically refresh and update itself, for example, every 5 seconds.

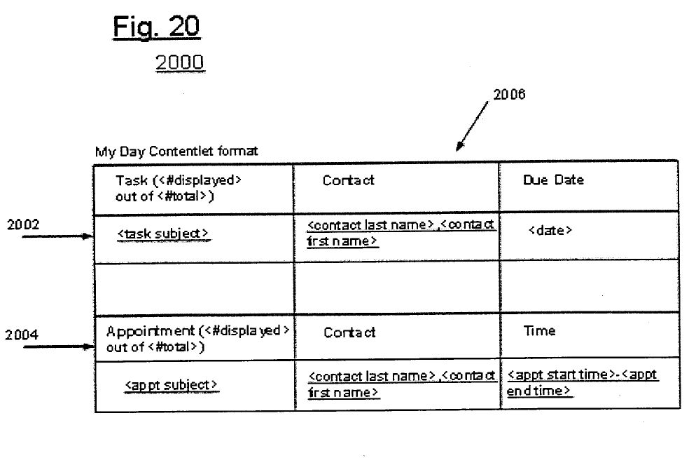

FIG. 20 is an example of a “My Day” contentlet format 2000, according to one embodiment of the invention. In the format depicted, the My Day contentlet 2000 can contain numerous boxes or display areas, providing information on or links relating to, for example, a displayed table 2006 or tables including a display of associated tasks, contacts, and due dates, as depicted in a format of the first row 2002, as well as associated appointments, contacts, and times, as depicted in a format of the second row 2004.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. In a networked computer system in which financial services are provided, a system for providing integrated availability of a plurality of applications, the system comprising:
a network;
at least one host server computer connected to the network;
at least one client computer connected to the at least one host server computer;
wherein, during a session between a first host server computer of the at least one host server computer and a first client computer of the at least one client computer, the first host server computer causes a Web page to be displayed on a display device of the first client computer, the Web page comprising a plurality of display areas, each of the display areas displaying initial content provided through a different set of one or more applications, and
wherein at least a portion of each of the display areas is selectable to cause a second window to be displayed on the display device, the window comprising additional content related to the content of the display area containing the selectable portion, and
wherein session information relating to the session is stored in a database separately from the first host server computer and separately from the first client computer, and
wherein session information is obtained from the database and used in causing at least one of the display of the second window and display of a window comprising further content related to the additional content.

2. The system of claim 1, wherein causing at least one of the display of the second window and display of a window comprising further content related to the additional content comprises the first host server computer communicating a request to a main application, and comprises the main application obtaining the session information, and comprises the main application causing communication of session information between at least two other applications.

3. In a networked computer system in which financial services are provided, a system for providing integrated availability of a plurality of applications, the system comprising:
at least one host server computer connected to the Internet;
at least one client computer connected to the at least one host server computer;
wherein, during a session between a first host server computer of the at least one host server computer and a first client computer of the at least one client computer, the first host server computer causes a Web page to be displayed on a display device of the first client computer, the Web page comprising a plurality of display areas, each of the display areas displaying initial content provided through a different set of one or more applications, and
wherein at least a portion of each of the display areas is selectable to cause a window to be displayed on the display device, the window comprising additional content related to the content of the display area containing the selectable portion, and
wherein session information relating to the session is stored in a database separately from the first host server computer and separately from the first client computer, and
wherein session information is obtained from the database and used in causing at least one of the display of the window and display of a window comprising further content related to the additional content.

4. The system of claim 3, wherein causing at least one of the display of the window and display of a window comprising further content related to the additional content comprises the first host server computer communicating a request to a main application, and comprises the main application obtaining the session information, and comprises the main application causing communication of session information between at least two other applications.

5. The system of claim 4, wherein the request is a Hypertext Transfer Protocol request, and wherein the communication of session information comprises the use of one or more Hypertext Transfer Protocol requests having session information included in headers of the requests.

6. The system of claim 3, wherein the set of one or more applications comprises one or more financial services applications.

7. The system of claim 3, comprising one or more application server computers connected to the Internet, and wherein at least one of the one or more applications of the set are provided through the one or more application servers.

8. The system of claim 3, wherein at least one of the one or more applications of the set are provided through at least a first host server computer of the at least one host server computer.

9. The system of claim 4, wherein the at least one host server computer comprises a global context services server computer comprising the database, and wherein session data, obtained for the first client computer during the session with the first host server computer, is stored in the database, and wherein the main application uses at least a portion of the session data in causing fulfillment of the request, and wherein fulfillment of the request requires use of data obtained from at least two applications.

10. The system of claim 9, wherein the request is a Hypertext Transfer Protocol request, and wherein the main application, to facilitate fulfillment of the request, causes a second Hypertext Transfer Protocol request to be communicated to a second application of the other applications.

11. The system of claim 9, wherein interaction of a user of a client computer with multiple applications via the Web page and windows accessed via the Web page is visibly indistinguishable to the user from interaction with a single application.

12. The system of claim 10, wherein the operation of the second application is transparent to a user of the first client computer.

13. The system of claim 3, wherein the first host server computer causes the Web page to be assembled dynamically according to entitlements of a user of the first client computer.

14. The system of claim 3, wherein the Web page includes content including at least one of real time data and almost real time data.

15. The system of claim 3, wherein the Web page is customizable according to preferences of a user of the client computer.

16. The system of claim 3, wherein at least a portion of the window is selectable to cause an additional window to be displayed, the additional window comprising the further content.

17. The system of claim 3, wherein the window allows access to one or more features of one or more applications through which the initial content was provided.

18. The system of claim 14, wherein the additional window allows access to one or more features of one or more applications through which the further content was provided.

19. The system of claim 3, wherein the second window comprises a site map.

20. The system of claim 3, wherein the Web page allows access to a favorites menu, the favorites menu allowing access to a plurality of applications, and the favorites menu being customizable by a user of the first client computer.

21. The system of claim 4, comprising a firewall that protects the at least one host server computer and the database from unrestricted public access.

22. In a networked computer system in which financial services are provided, the system comprising at least one server computer connected to the Internet and at least one client computer connected to the at least one server computer, a method for providing integrated availability of a plurality of applications, the method comprising:
during a session between a first host server computer of the at least one host server computer and a first client computer of the at least one client computer, the first host server computer causing a Web page to be displayed on a display device of the first client computer, the Web page comprising a plurality of display areas, each of the display areas displaying initial content provided through a different set of one or more applications;
displaying a window on the display device, the window comprising additional content related to the content of a display area of the plurality of display areas;
storing session information relating to the session in a database separately from the first host server computer and separately from the first client computer; and
using session information obtained from the database in causing at least one of the display of the window and display of a window comprising further content related to the additional content.

23. The method of claim 22, wherein causing at least one of the display of the window and display of a window comprising further content related to the additional content comprises:
the first host server computer communicating a request to a main application;
the main application obtaining the session information; and
the main application causing communication of session information between at least two other applications.

24. The method of claim 22, wherein the request is a Hypertext Transfer Protocol request, and wherein the communication of session information comprises sending one or more Hypertext Transfer Protocol requests having session information included in headers of the requests.

25. Computer usable media storing program code which, when executed on one or more computerized devices, causes the computerized devices to execute, in a networked computer system in which financial services are provided, the system comprising at least one server computer connected to the Internet and at least one client computer connected to the at least one server computer, a method for providing integrated availability of a plurality of applications, the method comprising:
during a session between a first host server computer of the at least one host server computer and a first client computer of the at least one client computer, the first host server computer causing a Web page to be displayed on a display device of the first client computer, the Web page comprising a plurality of display areas, each of the display areas displaying initial content provided through a different set of one or more applications;
displaying a window on the display device, the window comprising additional content related to the content of a display area of the plurality of display areas;
storing session information relating to the session in a database separately from the first host server computer and separately from the first client computer; and
using session information obtained from the database in causing at least one of the display of the window and display of a window comprising further content related to the additional content.
